(19) United States
(12) Patent Application Publication
(10) Pub. No.: US 2017/0223710 A1
(43) Pub. Date: Aug. 3, 2017

(54) SETTING PARAMETERS FOR JOINT OVERLAPPING BASIC SERVICE SET PACKET DETECT LEVEL AND TRANSMIT POWER

(71) Applicants: Laurent Cariou, Portland, OR (US); Po-Kai Huang, West Lafayette, IN (US); Robert J. Stacey, Portland, OR (US)

(72) Inventors: Laurent Cariou, Portland, OR (US); Po-Kai Huang, West Lafayette, IN (US); Robert J. Stacey, Portland, OR (US)

(21) Appl. No.: 15/192,433

(22) Filed: Jun. 24, 2016

Related U.S. Application Data
(60) Provisional application No. 62/289,118, filed on Jan. 29, 2016.

(51) Int. Cl. H04W 72/04; H04W 40/24; H04W 52/26

(52) U.S. Cl. CPC H04W 72/0473; H04W 52/26; H04W 40/244; H04W 84/12

(57) ABSTRACT

Apparatuses, methods, and computer readable media for setting parameters for joint overlapping basic service set packet detect level and transmit power. An apparatus is disclosed comprising processing circuitry configured to: determine an overlapping basic service set (OBSS) power detect (PD)(OBSS-PD) and a transmit power (TXP) based on first parameters, and if the wireless device has not received a frame from an OBSS master station that does not belong to a same management domain as the wireless device, determine the OBSS-PD and TXP based on second parameters. The second parameters may permit the wireless device to set the OBSS-PD to a higher value without lowering the TXP. The first parameters require that OBSS-PD and TXP be determined based on a minimum OBSS-PD and a maximum TXP, and require the OBSS-PD to be lowered if the TX power is raised.

### PRIORITY CLAIM

This application claims the benefit of priority under 35 USC 119(e) to U.S. Provisional Patent Application Ser. No. 62/289,118, filed Jan. 29, 2016, which is incorporated herein by reference in its entirety.

### TECHNICAL FIELD

Embodiments pertain to wireless networks and wireless communications. Some embodiments relate to wireless local area networks (WLANs) and Wi-Fi networks including networks operating in accordance with the IEEE 802.11 family of standards. Some embodiments relate to setting parameters for joint overlapping basic service set (OBSS) packet detect level (PD) and transmitter power (TXP).

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates a method for setting parameters for OBSS PD level and TXP in accordance with some embodiments;

FIG. 3 illustrates a wireless network in accordance with some embodiments;

FIG. 4 illustrates transmit and detect parameters in accordance with some embodiments;

FIG. 5 illustrates transmit and operating parameters in accordance with some embodiments;

FIG. 6 illustrates a method for setting parameters for joint overlapping basic service set packet detect level and transmit power in accordance with some embodiments;

FIG. 7 illustrates a method for setting parameters for joint overlapping basic service set packet detect level and transmit power in accordance with some embodiments; and

FIG. 8 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

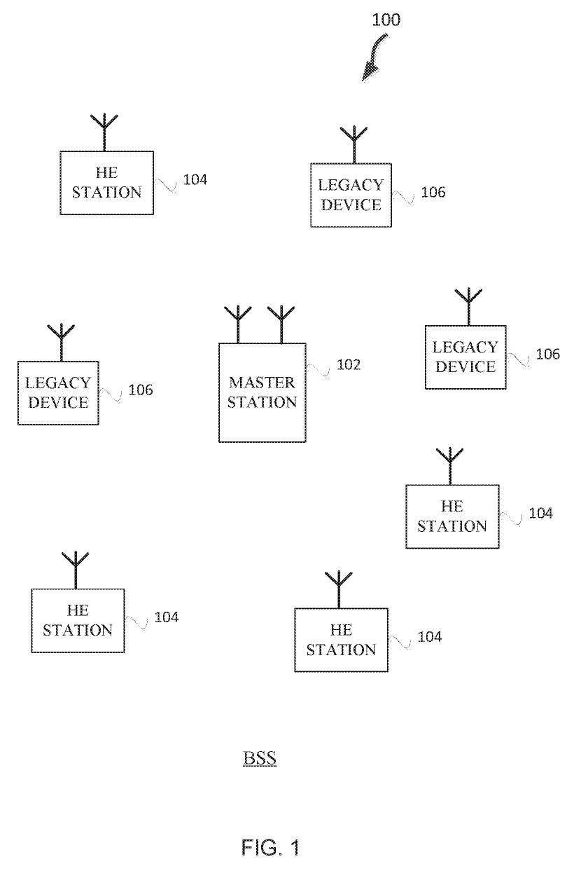

FIG. 1 illustrates a WLAN 100 in accordance with some embodiments. The WLAN may comprise a basis service set (BSS) 100 that may include a master station 102, which may be an AP, a plurality of high-efficiency (HE) (e.g., IEEE 802.11ax) stations 104, and a plurality of legacy (e.g., IEEE 802.11n/ac) devices 106.

The master station 102 may be an AP using one of the IEEE 802.11 protocols to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). The master station 102 and/or HE station 104 may use one or both of MU-MIMO and OFDMA. There may be more than one master station 102 that is part of an extended service set (ESS). A controller (not illustrated) may store information that is common to the more than one master station 102. The controller may have access to an external network such as the Internet.

The legacy devices 106 may operate in accordance with one or more of IEEE 802.11 a/b/g/n/ac/ad/af/ah/aj, or another legacy wireless communication standard. The legacy devices 106 may be STAs or IEEE 802.11 STAs. The HE stations 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol such as IEEE 802.11az. In some embodiments, the HE stations 104, master station 102, and/or legacy devices 106 may be termed wireless devices. In some embodiments the HE station 104 may be a “group owner” (GO) for peer-to-peer modes of operation where the HE station 104 may perform some operations of a master station 102.

The master station 102 may communicate with legacy devices 106 in accordance with legacy IEEE 802.11 communication techniques. In example embodiments, the master station 102 may also be configured to communicate with HE stations 104 in accordance with legacy IEEE 802.11 communication techniques.

In some embodiments, a HE frame may be configurable to have the same bandwidth as a channel. The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the channels may be based on a number of active subcarriers. In some embodiments the bandwidth of the channels are multiples of 26 (e.g., 26, 52, 104, etc.) active subcarriers or tones that are spaced by 20 MHz. In some embodiments the bandwidth of the channels are 26, 52, 104, 242, etc. active data subcarriers or tones that are space 20 MHz apart. In some embodiments the bandwidth of the channels is 256 tones spaced by 20 MHz. In some embodiments a 20 MHz channel may comprise 256 tones for a 256 point Fast Fourier Transform (FFT). In some embodiments, a different number of tones is used.

A HE frame may be configured for transmitting a number of spatial streams, which may be in accordance with MU-MIMO. In some embodiments, a HE frame may be configured for transmitting in accordance with one or both of OFDMA and MU-MIMO. In other embodiments, the master station 102, HE station 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, WiMAX, WiGig, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a HE master-sync transmission, which may be a trigger frame or HE control and schedule transmission, at the beginning of the HE control period. The master station 102 may transmit a time duration of the TXOP and channel information. During the HE control period, HE stations 104 may communicate with the master station 102 in accordance with a non-contention based multiple access technique such as OFDMA and/or MU-MIMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a channel smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission or TXOP. In some embodiments the trigger frame may indicate an uplink (UL) UL-MU-MIMO and/or UL OFDMA control period. In some embodiments, the trigger frame may indicate portions of the TXOP that are contention based for some HE stations 104 and portions that are not contention based, which may be termed random access. In some embodiments, the master station 102 may be configured to transmit a trigger frame for random access which may be for both associated and unassociated stations.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

In example embodiments, the HE device 104 and/or the master station 102 are configured to perform the methods and operations herein described in conjunction with FIGS. 1-8.

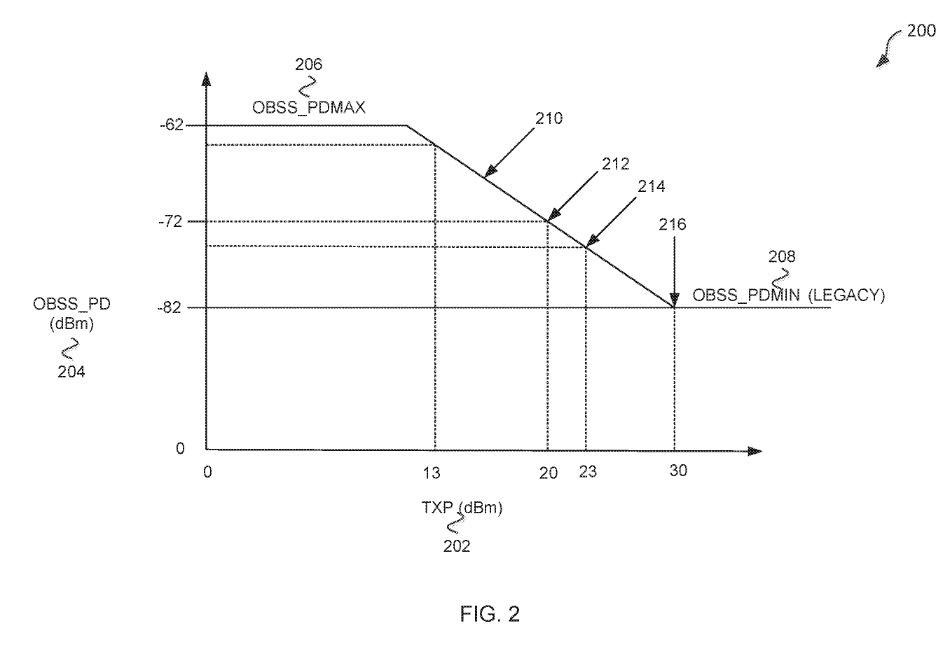

FIG. 2 illustrates a method 200 for setting parameters for OBSS PD level and TXP in accordance with some embodiments. Illustrated in FIG. 2 is TXP 204 along a horizontal axis, OBSS PD (dBm) 202 along a vertical axis, operating line 210, OBSS_PDMAX 206, and OBSS_PDMIN (legacy) 208. The OBSS PD (dBm) 204 may be an energy detection level. For example, the received signal strength indication (RSSI) may return a value after detecting received energy as part of clear channel assessment (CCA). If the detected energy level is below the OBSS_PD 204 setting, then the energy, which may be a packet, is ignored in that the station will not defer based on the received energy. In some embodiments, the OBSS PD (dBm) 204 may be an energy detect level that a master station 102 and/or HE station 104 may use to determine whether or not to spatially reuse the channel. For example, if OBSS PD (dBm) is below a set level, then the master station 102 and/or HE station 104 may begin transmitting a frame while still receiving the other frame. The OBSS_PDMAX 206 and OBSS_PDMIN (legacy) 208 may be in accordance with one or more communication standards. The TXP 202 is a power used to transmit packets. The OBSS_PD 204 and TXP 202 may be based on a bandwidth, e.g., 20 MHz.

The operating line 210 is a line defined by Equation (1): OBSS_PD_{TRESHOLD}=MAX[OBSS_PD_{TRESHOLD}_{_}_{MIN}(20 MHz), MIN(OBSS_PD_{TRESHOLD}_{_}_{MAX}, OBSS_PD_{TRESHOLD}_{_}_{MIN}+(TX_PWR_{MAX}−TX_PWR))], where the TX_PWR_{MAX}=to a maximum power of a station.

The operating line 210 may define combinations of TXP 202 and OBSS PD 204 a master station 102 and/or HE station 104 may select for operating. In some embodiments, the higher the TXP 202, then the lower the OBSS PD 204 the master station 102 and/or HE station 104 selects. For example, the master station 102 and/or HE station 104 may use TXP 202 of 20 dBm and an OBSS PD 204 of −72 dBm, which may be at point 212 of operating line 210. If the master station 102 and/or HE station 104 wants to use a greater TXP 202, e.g., 23 dBm, then the master station 102 and/or HE station 104 increases the sensitivity of OBSS PD dBm 204 to −75 dBm, which may be at point 214 of operating line 210. TXP 202 of 13 dBm may be a minimum TXP 202.

The following is an example use of equation (1) for TXP 202 of 20 dBM, OBSS_PD_{TRESHOLD}=MAX[OBSS_PD_{TRESHOLD}_{_}_{MIN}(20 MHz) (=−82), MIN(OBSS_PD_{TRESHOLD}_{_}_{MAX}(=−62), OBSS_PD_{TRESHOLD}_{_}_{MIN}(=−82)+(TX_PWR_{MAX}(=30)−TX_PWR (=20 given))], which derives: OBSS_PD_{TRESHOLD}=MAX[−82, MIN(−62, −82+30−20))]=MAX[−82, MIN(−62, −82+10))]=MAX[−82, MIN(−62, −82+10))]=MAX[−82, MIN(−62, −72))]=MAX[−82, MIN(−72))]=MAX[−72]=−72, which is in agreement with point 212.

Point 216 may be the default parameters for TXP 202 30 dBm and OBSS PD 204 −82 dBm for legacy devices 106 for 20 MHz bandwidth. The default parameters for 40 MHz bandwidth may be −79 dBm for OBSS PD 204. The master station 102 and/or HE stations 104 may use the OBSS PD 204 to determine whether to spatially reuse the bandwidth.

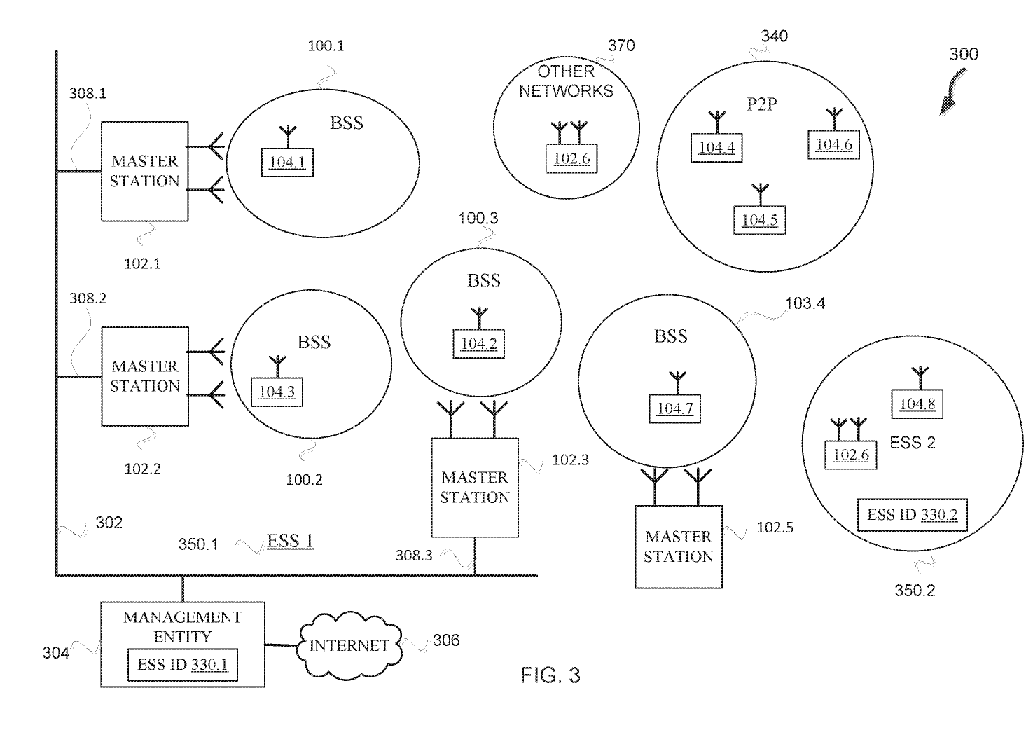

FIG. 3 illustrates a wireless network 300 in accordance with some embodiments. Illustrated in FIG. 3 is extended service set (ESS) 1 350.1, other networks 370, OBSS 332, ESS 2 350.2, master stations 102, management entity 304, Internet 306, and peer-to-peer (P2P) 340. The wireless network 300 may represent different networks that are available in a high density area such as a football stadium.

The ESS 1 350.1 comprises three BSSs 100.1, 100.2, and 100.3. The master stations 102.1, 102.2, and 102.3 are part of their respective BSSs 100.1, 100.2, and 100.3. The master stations 102 are coupled to a backbone 202 through communication links 308.1, 308.2, and 308.3. The backbone 302 may be any technology that provides the appropriate services to the ESS 350.1. For example, the backbone 302 may be Ethernet cables or wireless. The communication links 308 may be cables or wireless links.

The management entity 304 may be a router that routes 304 packets based on destination addresses. The management entity 304 may include functionality for managing ESS 1 350.1 such as setting the transmit and detect parameters 400 for one or more of the master stations 102.1, 102.2, and 102.3 and/or HE devices 104 that are part of the BSSs 100.1, 100.2, and 100.3. The management entity 304 may coordinate transmit and detect parameters 400 for devices the management entity 304 is managing such as all the wireless devices that are part of the ESS 1 350.1. In some embodiments, the management entity 304 may be a distribution system (DS).

The Internet 206 may be the Internet. The master stations 102.1, 102.2, and 102.3, are given the same service set identifier (SSID). The BSSs 100.1, BSS 100.2, and 100.3 may overlap with one another. A BSS 100 that overlaps another BSS 100 may be termed an overlapping BSS (OBSS) to the other BSS 100. For example, BSS 100.2 may overlap BSS 100.3, which would mean signals from the BSS 100.2 would reach one or more wireless devices that are part of the BSS 100.3, e.g. the master station 102.3 or HE station 104.2.

In accordance with some embodiments, master stations 102 that are part of the same ESS 350 may be termed neighbor access points or master stations 102 to other access points or master stations 102 of the same ESS 350. For example, master station 102.1 is a neighbor access point or master station 102.1 to master stations 102.2, and 102.3. Master stations 102 may send information regarding the master station 102 and BSS 100 to neighbor master stations 102. The master stations 102 may be configured to operate on different primary channels.

BSS 103.4 may not be part of ESS 1 350.1 or ESS 2 350.2. In some embodiments, master station 102.5 may be termed an unmanaged AP because it may not be part of the management entity 304. In some embodiments signals from wireless devices of ESS 1 350.1, ESS 2 350.2, BSS 103.4, P2P 340, and/or other networks 370 may reach one or more of the following BSSs 100 of ESS 1 350.1, ESS 2 350.2, other networks 370, and/or P2P 340. For example, beacons from master station 102.6 of ESS 2 350.2 may reach HE station 104.1. I

Other networks 370 may be other networks that generate signals. For example, other networks 370 may be a Long-Term Evolution (LTE) license assisted access (LAA). P2P 340 may be a network of HE station 104 where one or more HE stations 104 are using P2P to communicate and/or one or more of the HE station 104 are acting as a GO. In some embodiments, the HE stations 104, acting as a master station 102, with at least some of the functionality of the master station 102, may be termed soft APs. ESS 2 350.2 may be similar or the same as ESS 1 350.1. In some embodiments ESS 1 350.1 and ESS 2 350.2 may communicate with one another, e.g. management entity 304 may communicate with a management entity (not illustrated) of ESS 2 350.2, or ESS 1 350.1 and ESS 2 350.2 may have a common management entity (not illustrated).

In some embodiments, an ESS 350 my advertise transmit and operating parameters 500 (see FIG. 5), e.g. master station 102.1 may advertise transmit and operating parameters 500 in a beacon frame that is received by HE station 104.4 that is acting as a GO, and HE station 104.4 may use the transmit and operating parameters 500. In some embodiments, the HE station 104.4 and/or a master station 102 may use the ESS ID 330.1 of ESS 350.1.

In some embodiments a master station 102 may determine transmit and detect parameters 400 for determining OBSS_PD and/or TXP and may transmit the determine transmit and detect parameters 400 to one or more HE stations 104. The master station 102 may send transmit and detect parameters 400 in beacon frames or pre-association frames in accordance with some embodiments.

In some embodiments, if conditions are not met, the master station 102 has to use and send default parameters for the transmit and detect parameters 400. For example, the conditions may include not receiving frames from a different management entity than the master station 102 is attached to. The HE stations 104 may have to use the default parameters if the conditions are not met. The default parameters may be defined in a communication specification. For the OBSS_PD_min parameters, the default value may be the default legacy power detect (PD) level (e.g., −82 dBm for 20 MHz, −79 dBm for 40 MHz, etc).

In some embodiments, the master station 102 and/or HE stations 104 may be configured to determine if a frame is from a wireless device from a different management entity based on the ESS ID 330.

The HE stations 104 may be configured to forward frames from other management entities. For example, HE station 104.7 may forward a beacon with transmit and detect parameters 400 being used by ESS 1 330.1 to the master station 102.5 that the HE station 104.7 is associated with.

In some embodiments, if a master station 102 receives a frame from a different management entity (e.g., ESS 330), then the master station 102 may switch to default parameters for transmit and detect parameters 400 and not notify other master stations 102 of the receipt of the frame. In some embodiments, if a master station 102 receives a frame from a different management entity (e.g., ESS 330) and on a primary channel the master station 102 is operating on, then the master station 102 may switch to default parameters for transmit and detect parameters 400 and not notify other master stations 102 of the receipt of the frame. In some embodiments, the master station 102 will not switch to default parameters if it receives a frame from a different management entity on a secondary channel.

In some embodiments, the master station 102 does send a frame to notify other master stations 102 in the same management entity to switch to default parameters or parameters based on the received frame. For example, master station 308.3 may receive a beacon frame from master station 102.5. Master station 102.3 may switch to default parameters and notify master station 102.1 and 102.2 to switch to default parameters.

In some embodiments, P2P 340 may operate on channel that are included in operating parameters 500. For example, master station 102.3 may send a beacon with operating parameters 500. HE stations 104.4, 104.5, and 104.6 may receive the beacon frame and operate on the channels indicated in the operating parameters 500. If frames are received by a master station 102 of ESS 1 350.1 the master station 102 may determine it does not have to switch to default parameters if the frames are within the channels indicated in the operating parameters 500.

In some embodiments, HE stations 104.4, 104.5, and 104.6 may receive the beacon frame and operate on the channels indicated in the operating parameters 500. The beacon frame may also include transmit and detect parameters 400. The HE stations 104.4, 104.5, and 104.6 may operate using the transmit and detect parameters 400 if they also operate on the channels indicated in the operating parameters 500.

In some embodiments, P2P 340 HE stations 104 may use an ESS 350 that they are not attached to as an ID in packets to interoperate with the ESS 350.

In some embodiments, a master station 102 may assume that if a frame from another master station 102 does not include transmit and detect parameters 400 that default parameters for detect parameters 400 are indicated.

In some embodiments, a master station 102 may set transmit and detect parameters 400 such as raising the OBSS PD 204 without lowering the TXP 202 if there are no other master stations 102 and/or HE stations 104 acting as P2P 340 detected.

Master stations 102 may ignore OBSS beacons from the same managed entity, in accordance with some embodiments. This avoids one modification to a master station 102 of a management entity propagating to all the other master station 102 of the management entity, e.g., master station 102.2 may ignore beacons from master station 102.3.

In some embodiments, if a master station 102 receives transmit and detect parameters 400 from different managed entity with a value lower than the parameters currently being used by the master station 102, then the master station 102 changes the transmit and detect parameters it is using to the received transmit and detect parameters. In some embodiments, the master station 102 may change the transmit and detect parameters 400 to be higher than the received transmit and detect parameters 400.

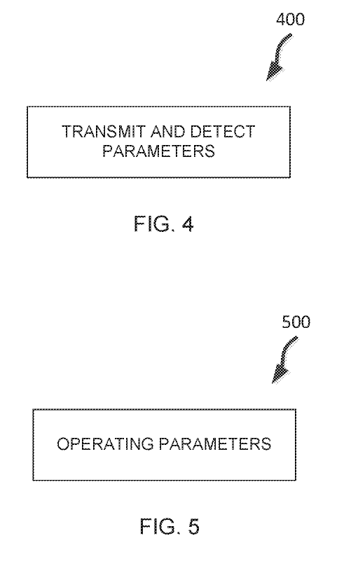

FIG. 4 illustrates transmit and detect parameters 400 in accordance with some embodiments. The transit and detect parameters may include one or more of OBSS_PDMIN 208, OBSS_PDMAX 206, TXP 202, and OBSS_PD 204. In some embodiments additional parameters may be included that may determine how a master station 102 and/or HE station 104 operate. For example, the parameters may include an indication of whether the master station 102 and/or HE station 104 may raise the value of OBSS_PD 204 without lowering the TXP 202.

The parameters 400 may be included in one or more frames, e.g. beacon frames, pre-association frames, and post-association frames. The parameters 400 may be an information element or may be fixed fields in a frame types. In some embodiments, there may be default parameters, e.g. for legacy devices 106 −82 dBm for OBSS_PD 204 for 20 MHz bandwidth and −79 dBm for 40 MHz bandwidth. In some embodiments, the transmit and detect parameters 400 may be termed spatial reuse parameters.

FIG. 5 illustrates transmit and operating parameters 500 in accordance with some embodiments. The operating parameters 500 may be channel selections and/or transmit and detect parameters 500 for a master station 102 and/or HE station 104 to use. For example, the operating parameters 500 may include channels such as one or more 20 MHz channels for a master station 102 to use and an indication OBSS_PD 204 for the master station 102 to use.

The transmit and operating parameters 500 may be included in one or more frames, e.g. beacon frames, pre-association frames, and post-association frames. The transmit and operating parameters 500 may be an information element or may be fixed fields in a frame types.

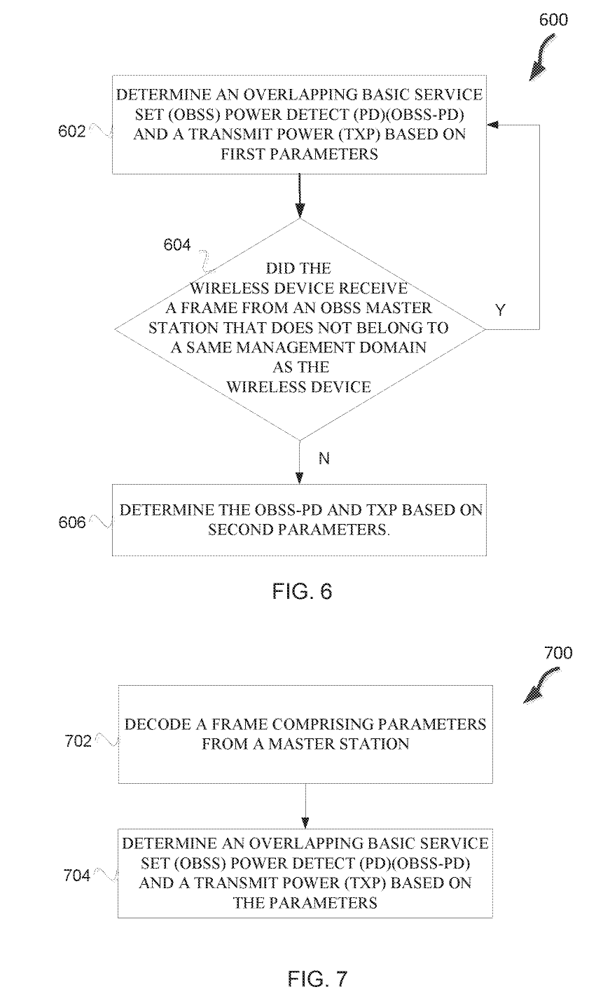

FIG. 6 illustrates a method 600 for setting parameters for joint overlapping basic service set packet detect level and transmit power in accordance with some embodiments. The method 600 begins at operation 602 with determining an overlapping basic service set (OBSS) power detect (PD)(OBSS-PD) and a transmit power (TXP) based on first parameters. For example, the first parameters may require that OBSS-PD and TXP be determined based on a minimum OBSS-PD and a maximum TXP, and require the OBSS-PD to be lowered if the TX power is raised. In some embodiments, the first parameters require that OBSS-PD and TXP be determined based on a minimum OBSS-PD and a maximum TXP, and require the OBSS-PD to be lowered if the TX power is raised. In some embodiments, the first parameters indicate that OBSS-PD and TXP are to be determined based on a minimum OBSS-PD and a maximum TXP, and indicate the OBSS-PD is to be lowered if the TX power is raised.

The method 600 may continue at operation 604 with did the wireless device receive a frame from an OBSS master station that does not belong to a same management domain as the wireless device. For example, referring to FIG. 3, master station 102.2 may have received a packet from master station 102.5. The management domain may be the ESS 1 350.1. In some embodiments, operation 604 is did the wireless device receive a frame from an OBSS master station that does not belong to a same management domain as the wireless device, where the frame was received on the primary channel of the wireless device.

The method 600 returns to operation 602 if the wireless device did receive a frame from an OBSS master station that does not belong to a same management domain as the wireless device.

The method 600 continues at operation 606 if the wireless device did not receive a frame from an OBSS master station that does not belong to a same management domain as the wireless device (and, in some embodiments, the frame may also be on the primary channel). For example, the second parameters may permit the wireless device to set the OBSS-PD to a higher value without lowering the TXP. For example, referring to FIG. 2, a master station 102 and/or HE station 104 may set the OBSS_PD 204 to −72 while maintaining a TXP 202 of 30 dBm. The method 600 may end or continue with additional operations.

FIG. 7 illustrates a method 700 for setting parameters for joint overlapping basic service set packet detect level and transmit power in accordance with some embodiments. The method 700 begins at operation 702 with decoding a frame comprising parameters from a master station. For example, referring to FIG. 3, HE station 104.7 may receive a beacon frame from master station 102.5 or master station 102.3.

The method 700 continues at operation 704 with determining an overlapping basic service set (OBSS) power detect (PD)(OBSS-PD) and a transmit power (TXP) based on the parameters. For example, the parameters may be one of the following: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP. In some embodiments the first parameters indicate that OBSS-PD and TXP are to be determined based on a minimum OBSS-PD and a maximum TXP, and indicate the OBSS-PD is to be lowered if the TX power is raised. The method 700 may end or continue with additional operations.

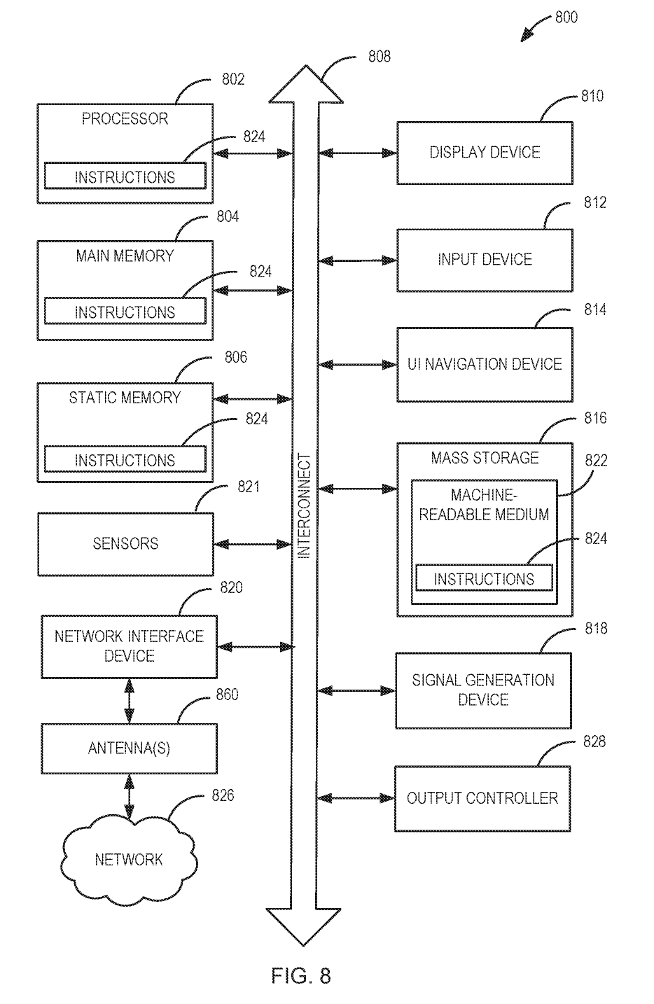

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display device 810, an input device 812 (e.g., a keyboard), and a user interface (UI) navigation device 814 (e.g., a mouse). In an example, the display device 810, input device 812 and UI navigation device 814 may be a touch screen display. The machine 800 may additionally include a mass storage (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 802 and/or instructions 824 may comprise processing circuitry and/or transceiver circuitry.

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

An apparatus of the machine 800 may be one or more of a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 820 may include one or more physical jacks (e.g., Ethernet, coaxial, or phone jacks) or one or more antennas to connect to the communications network 826. In an example, the network interface device 820 may include one or more antennas 860 to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

Various embodiments disclosed herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of a wireless device including: memory; and processing circuitry coupled to the memory, the processing circuitry configured to: determine an overlapping basic service set (OBSS) power detect (PD)(OBSS-PD) and a transmit power (TXP) based on first parameters; and if the wireless device has not received a frame on a primary channel from an OBSS master station that does not belong to a same management domain as the wireless device, determine the OBSS-PD and TXP based on second parameters.

In Example 2, the subject matter of Example 1 optionally includes where the second parameters permit the wireless device to set the OBSS-PD to a higher value without lowering the TXP.

In Example 3, the subject matter of any one or more of Examples 1-2 optionally include where the first parameters indicate that OBSS-PD and TXP are to be determined based on a minimum OBSS-PD and a maximum TXP, and indicate the OBSS-PD is to be lowered if the TX power is raised.

In Example 4, the subject matter of any one or more of Examples 1-3 optionally include where the frame from the OBSS master station is a beacon frame or a management frame.

In Example 5, the subject matter of any one or more of Examples 1-4 optionally include where the processing circuitry is further configured to: encode a transmit and operating parameters information element, the transmit and operating parameters information element including channels for second wireless devices that do not belong to the same management domain to operate on; and configure the wireless device to broadcast the information element.

In Example 6, the subject matter of Example 5 optionally includes where the processing circuitry is further configured to: if the wireless device has not received the frame from the OBSS master station that does not belong to the same management domain as the wireless device, or if the frame is received from the OBSS master station that operates in accordance with the transmit and operating parameters information element, determine the OBSS-PD and the TXP based on second parameters.

In Example 7, the subject matter of any one or more of Examples 1-6 optionally include the processing circuitry is further configured to: if the wireless device has not received the frame from the OBSS master station that does not belong to the same management domain as the wireless device, or if the frame is received from the OBSS master station that operates in accordance with the transmit and operating parameters information element, determine the OBSS-PD and the TXP based on second parameters.

In Example 8, the subject matter of any one or more of Examples 1-7 optionally include where the processing circuitry is further configured to: determine the OBSS power detect and the TX power to be default values in response to receiving a second frame that indicates the OBSS master station is part of an unmanaged network.

In Example 9, the subject matter of any one or more of Examples 1-8 optionally include where the processing circuitry is circuitry is further configured to: determine the OBSS-PD and TXP based on the first parameters, where OBSS-PD is determined in accordance with the following equation: OBSS-PD=MAX[OBSS_PDTRESHOLD_MIN, MIN(OBSS_PDTRESHOLD_MAX, OBSS_PDTRESHOLD_MIN+(TX_PWRMAX−TXP))], where OBSS_PDTRESHOLD_MIN, OBSS_PDTRESHOLD_MAX, and TX_PWRMAX are predetermined constants, and where the TXP is selected to be less than TX_PWRMAX.

In Example 10, the subject matter of any one or more of Examples 1-9 optionally include where the processing circuitry is further configured to: if the wireless device has received the frame from the OBSS master station that does not belong to a same management domain as the wireless device, and the frame indicates the OBSS-PD is lower than a second OBSS-PD of the OBSS master station, determine the OBSS-PD and TXP based on second parameters, where OBSS-PD is kept lower than the second OBSS-PD.

In Example 11, the subject matter of any one or more of Examples 1-10 optionally include where the processing circuitry is further configured to: if a second frame from a station attached to the wireless device is decoded that indicates the station received a third frame from the OBSS master station, determine the OBSS-PD and TXP based on the first parameters.

In Example 12, the subject matter of any one or more of Examples 1-11 optionally include where the processing circuitry is further configured to: receive third parameters from the same management entity; and determine the OBSS-PD and TXP based on the third parameters.

In Example 13, the subject matter of Example 12 optionally includes where the third parameters comprise one or more of the following: OBSS-PD minimum value, a TXP maximum value, an indication to lower TXP if OBSS-PD is raised, a default OBSS-PD to set OBSS-PD to, and a default TXP to set TXP to.

In Example 14, the subject matter of any one or more of Examples 1-13 optionally include where the processing circuitry is further configured to: decode a second frame from the OBSS master station that does not belong to the same management domain, where if the second frame comprises third parameters including a second OBSS-PD, set the OBSS-PD to either a lower value than the second OBSS-PD or a same value as the second OBSS-PD, and if the second frame does not include third parameters, then set the OBSS-PD to a default OBSS-PD.

In Example 15, the subject matter of any one or more of Examples 1-14 optionally include where the wireless device and master station are each one from the following group: an Institute of Electrical and Electronic Engineers (IEEE) 15 is missing parent: 15 is missing parent: 15 is missing parent: 15 is missing parent: 802.11ax access point, an IEEE 802.11ax station, an IEEE 802.1 lay access point, a IEEE 802.11ay station, a station, and an access point.

In Example 16, the subject matter of any one or more of Examples 1-15 optionally include transceiver circuitry coupled to the memory.

In Example 17, the subject matter of Example 16 optionally includes one or more antennas coupled to the transceiver circuitry.

Example 18 is a non-transitory computer-readable storage medium that stores instructions for execution by one or more processors, the instructions to configure the one or more processors to cause a master station to: determine an overlapping basic service set (OBSS) power detect (PD)(OBSS-PD) and a transmit power (TXP) based on first parameters; and if the wireless device has not received a frame from an OBSS master station that does not belong to a same management domain as the wireless device, determine the OBSS-PD and TXP based on second parameters.

In Example 19, the subject matter of Example 18 optionally includes where the second parameters permit the wireless device to set the OBSS-PD to a higher value without lowering the TXP, and where the first parameters indicate that OBSS-PD and TXP are to be determined based on a minimum OBSS-PD and a maximum TXP, and indicate the OBSS-PD is to be lowered if the TX power is raised.

Example 20 is a method performed by an access point, the method including: determine an overlapping basic service set (OBSS) power detect (PD)(OBSS-PD) and a transmit power (TXP) based on first parameters; and if the wireless device has not received a frame from an OBSS master station that does not belong to a same management domain as the wireless device, determine the OBSS-PD and TXP based on second parameters.

In Example 21, the subject matter of Example 20 optionally includes where the second parameters permit the wireless device to set the OBSS-PD to a higher value without lowering the TXP, and where the first parameters require that OBSS-PD and TXP be determined based on a minimum OBSS-PD and a maximum TXP, and require the OBSS-PD to be lowered if the TX power is raised.

Example 22 is an apparatus of a station including memory and processing circuitry coupled to the memory, the processing circuitry configured to: decode a frame including parameters from a master station; and determine an overlapping basic service set (OBSS) power detect (PD)(OBSS-PD) and a transmit power (TXP) based on the parameters, where the parameters are one from the following group: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP.

In Example 23, the subject matter of Example 22 optionally includes where the processing circuitry is further configured to: decode a second frame from a second master station not part of a same management entity as the master station, where the second frame comprises second parameters; encode a third frame including the second parameters; and configure the station to transmit the third frame to the master station.

In Example 24, the subject matter of any one or more of Examples 22-23 optionally include where the station is not associated with the master station and the parameters further comprise a transmit and operating parameters information element, the transmit and operating parameters information element including channels for the station to operate on.

In Example 25, the subject matter of any one or more of Examples 22-24 optionally include transceiver circuitry coupled to the memory; and, one or more antennas coupled to the transceiver circuitry.

Example 26 is an apparatus of a wireless device, the apparatus including: means for determining an overlapping basic service set (OBSS) power detect (PD)(OBSS-PD) and a transmit power (TXP) based on first parameters; and if the wireless device has not received a frame on a primary channel from an OBSS master station that does not belong to a same management domain as the wireless device, means for determining the OBSS-PD and TXP based on second parameters.

In Example 27, the subject matter of Example 26 optionally includes where the second parameters permit the wireless device to set the OBSS-PD to a higher value without lowering the TXP.

In Example 28, the subject matter of any one or more of Examples 26-27 optionally include where the first parameters require that OBSS-PD and TXP be determined based on a minimum OBSS-PD and a maximum TXP, and require the OBSS-PD to be lowered if the TX power is raised.

In Example 29, the subject matter of any one or more of Examples 26-28 optionally include where the frame from the OBSS master station is a beacon frame or a management frame.

In Example 30, the subject matter of any one or more of Examples 26-29 optionally include means for encoding a transmit and operating parameters information element, the transmit and operating parameters information element including channels for second wireless devices that do not belong to the same management domain to operate on; and means for configuring the wireless device to broadcast the information element.

In Example 31, the subject matter of Example 30 optionally includes if the wireless device has not received the frame from the OBSS master station that does not belong to the same management domain as the wireless device, or if the frame is received from the OBSS master station that operates in accordance with the transmit and operating parameters information element, means for determining the OBSS-PD and the TXP based on second parameters.

In Example 32, the subject matter of any one or more of Examples 26-31 optionally include if the wireless device has not received the frame from the OBSS master station that does not belong to the same management domain as the wireless device, or if the frame is received from the OBSS master station that operates in accordance with the transmit and operating parameters information element, means for determining the OBSS-PD and the TXP based on second parameters.

In Example 33, the subject matter of any one or more of Examples 26-32 optionally include means for determining the OBSS power detect and the TX power to be default values in response to receiving a second frame that indicates the OBSS master station is part of an unmanaged network.

In Example 34, the subject matter of any one or more of Examples 26-33 optionally include means for determining the OBSS-PD and TXP based on the first parameters, where OBSS-PD is determined in accordance with the following equation: OBSS-PD=MAX[OBSS_PDTRESHOLD_MIN, MIN(OBSS_PDTRESHOLD_MAX, OBSS_PDTRESHOLD_MIN+(TX_PWRMAX−TXP))], where OBSS_PDTRESHOLD_MIN, OBSS_PDTRESHOLD_MAX, and TX_PWRMAX are predetermined constants, and where the TXP is selected to be less than TX_PWRMAX.

In Example 35, the subject matter of any one or more of Examples 26-34 optionally include if the wireless device has received the frame from the OBSS master station that does not belong to a same management domain as the wireless device, and the frame indicates the OBSS-PD is lower than a second OBSS-PD of the OBSS master station, means for determining the OBSS-PD and TXP based on second parameters, where OBSS-PD is kept lower than the second OBSS-PD.

In Example 36, the subject matter of any one or more of Examples 26-35 optionally include if a second frame from a station attached to the wireless device is decoded that indicates the station received a third frame from the OBSS master station, means for determining the OBSS-PD and TXP based on the first parameters.

In Example 37, the subject matter of any one or more of Examples 26-36 optionally include means for receiving third parameters from the same management entity; and means for determining the OBSS-PD and TXP based on the third parameters.

In Example 38, the subject matter of Example 37 optionally includes where the third parameters comprise one or more of the following: OBSS-PD minimum value, a TXP maximum value, an indication to lower TXP if OBSS-PD is raised, a default OBSS-PD to set OBSS-PD to, and a default TXP to set TXP to.

In Example 39, the subject matter of any one or more of Examples 26-38 optionally include means for decoding a second frame from the OBSS master station that does not belong to the same management domain, where if the second frame comprises third parameters including a second OBSS-PD, means for setting the OBSS-PD to either a lower value than the second OBSS-PD or a same value as the second OBSS-PD, and if the second frame does not include third parameters, then set the OBSS-PD to a default OBSS-PD.

In Example 40, the subject matter of any one or more of Examples 26-39 optionally include where the wireless device and master station are each one from the following group: an Institute of Electrical and Electronic Engineers (IEEE) 40 is missing parent: 40 is missing parent: 40 is missing parent: 40 is missing parent: 802.11ax access point, an IEEE 802.11 lax station, an IEEE 802.11 lay access point, a IEEE 802.1 lay station, a station, and an access point.

In Example 41, the subject matter of any one or more of Examples 26-40 optionally include means for storing and retrieving data.

In Example 42, the subject matter of Example 41 optionally includes means for transmitting and receiving radio signals.

Example 43 is a non-transitory computer-readable storage medium that stores instructions for execution by one or more processors, the instructions to configure the one or more processors to cause a station to: decode a frame including parameters from a master station; and determine an overlapping basic service set (OBSS) power detect (PD)(OBSS-PD) and a transmit power (TXP) based on the parameters, where the parameters are one from the following group: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP.

In Example 44, the subject matter of Example 43 optionally includes where the instructions further configure the one or more processors to cause the station to: decode a second frame from a second master station not part of a same management entity as the master station, where the second frame comprises second parameters; encode a third frame including the second parameters; and configure the station to transmit the third frame to the master station.

In Example 45, the subject matter of any one or more of Examples 43-44 optionally include where the station is not associated with the master station and the parameters further comprise a transmit and operating parameters information element, the transmit and operating parameters information element including channels for the station to operate on.

Example 46 is a method performed by a station, the method including: decoding a frame including parameters from a master station; and determining an overlapping basic service set (OBSS) power detect (PD)(OBSS-PD) and a transmit power (TXP) based on the parameters, where the parameters are one from the following group: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP.

In Example 47, the subject matter of Example 46 optionally includes decoding a second frame from a second master station not part of a same management entity as the master station, where the second frame comprises second parameters; encoding a third frame including the second parameters; and configuring the station to transmit the third frame to the master station.

In Example 48, the subject matter of any one or more of Examples 46-47 optionally include where the station is not associated with the master station and the parameters further comprise a transmit and operating parameters information element, the transmit and operating parameters information element including channels for the station to operate on.

Example 49 is an apparatus of Example 48, the apparatus including: means for decoding a frame including parameters from a master station; and means for determining an overlapping basic service set (OBSS) power detect (PD)(OBSS-PD) and a transmit power (TXP) based on the parameters, where the parameters are one from the following group: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP.

In Example 50, the subject matter of Example 49 optionally includes means for decoding a second frame from a second master station not part of a same management entity as the master station, where the second frame comprises second parameters; means for encoding a third frame including the second parameters; and means for configuring the station to transmit the third frame to the master station.

In Example 51, the subject matter of any one or more of Examples 49-50 optionally include where the station is not associated with the master station and the parameters further comprise a transmit and operating parameters information element, the transmit and operating parameters information element including channels for the station to operate on.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device comprising: memory; and processing circuitry coupled to the memory, the processing circuitry configured to:
determine an overlapping basic service set (OBSS) power detect (PD)(OBSS-PD) and a transmit power (TXP) based on first parameters; and
if the wireless device has not received a frame on a primary channel from an OBSS master station that does not belong to a same management domain as the wireless device, determine the OBSS-PD and TXP based on second parameters.

2. The apparatus of claim 1, wherein the second parameters permit the wireless device to set the OBSS-PD to a higher value without lowering the TXP.

3. The apparatus of claim 1, wherein the first parameters indicate that OBSS-PD and TXP are to be determined based on a minimum OBSS-PD and a maximum TXP, and indicate the OBSS-PD is to be lowered if the TX power is raised.

4. The apparatus of claim 1, wherein the frame from the OBSS master station is a beacon frame or a management frame.

5. The apparatus of claim 1, wherein the processing circuitry is further configured to:
encode a transmit and operating parameters information element, the transmit and operating parameters information element comprising channels for second wireless devices that do not belong to the same management domain to operate on; and
configure the wireless device to broadcast the information element.

6. The apparatus of claim 5, wherein the processing circuitry is further configured to:
if the wireless device has not received the frame from the OBSS master station that does not belong to the same management domain as the wireless device, or if the frame is received from the OBSS master station that operates in accordance with the transmit and operating parameters information element, determine the OBSS-PD and the TXP based on second parameters.

7. The apparatus of claim 1, the processing circuitry is further configured to:
if the wireless device has not received the frame from the OBSS master station that does not belong to the same management domain as the wireless device, or if the frame is received from the OBSS master station that operates in accordance with the transmit and operating parameters information element, determine the OBSS-PD and the TXP based on second parameters.

8. The apparatus of claim 1, wherein the processing circuitry is further configured to:
determine the OBSS power detect and the TX power to be default values in response to receiving a second frame that indicates the OBSS master station is part of an unmanaged network.

9. The apparatus of claim 1, wherein the processing circuitry is circuitry is further configured to:
determine the OBSS-PD and TXP based on the first parameters, wherein OBSS-PD is determined in accordance with the following equation: OBSS-PD=MAX[OBSS_PD_{TRESHOLD}_{_{—MIN}}, MIN(OBSS_PD_{TRESHOLD}_{_}_{MAX}, OBSS_PD_{TRESHOLD}_{_}_{MIN}+(TX_PWR_{MAX}−TXP))], wherein OBSS_PD_{TRESHOLD}_{_}_{MIN}, OBSS_PD_{TRESHOLD}_{_}_{MAX}, and TX_PWR_{MAX} are predetermined constants, and wherein the TXP is selected to be less than TX_PWR_{MAX}.

10. The apparatus of claim 1, wherein the processing circuitry is further configured to:
if the wireless device has received the frame from the OBSS master station that does not belong to a same management domain as the wireless device, and the frame indicates the OBSS-PD is lower than a second OBSS-PD of the OBSS master station, determine the OBSS-PD and TXP based on second parameters, wherein OBSS-PD is kept lower than the second OBSS-PD.

11. The apparatus of claim 1, wherein the processing circuitry is further configured to:
if a second frame from a station attached to the wireless device is decoded that indicates the station received a third frame from the OBSS master station, determine the OBSS-PD and TXP based on the first parameters.

12. The apparatus of claim 1, wherein the processing circuitry is further configured to:
receive third parameters from the same management entity; and
determine the OBSS-PD and TXP based on the third parameters.

13. The apparatus of claim 12, wherein the third parameters comprise one or more of the following: OBSS-PD minimum value, a TXP maximum value, an indication to lower TXP if OBSS-PD is raised, a default OBSS-PD to set OBSS-PD to, and a default TXP to set TXP to.

14. The apparatus of claim 1, wherein the processing circuitry is further configured to:
decode a second frame from the OBSS master station that does not belong to the same management domain, wherein if the second frame comprises third parameters comprising a second OBSS-PD, set the OBSS-PD to either a lower value than the second OBSS-PD or a same value as the second OBSS-PD, and if the second frame does not include third parameters, then set the OBSS-PD to a default OBSS-PD.

15. The apparatus of claim 1, wherein the wireless device and master station are each one from the following group: an Institute of Electrical and Electronic Engineers (IEEE) 802.11ax access point, an IEEE 802.11ax station, an IEEE 802.11 ay access point, a IEEE 802.11 ay station, a station, and an access point.

16. The apparatus of claim 1, further comprising: transceiver circuitry coupled to the memory.

17. A non-transitory computer-readable storage medium that stores instructions for execution by one or more processors, the instructions to configure the one or more processors to cause a master station to:
determine an overlapping basic service set (OBSS) power detect (PD)(OBSS-PD) and a transmit power (TXP) based on first parameters; and
if the wireless device has not received a frame from an OBSS master station that does not belong to a same management domain as the wireless device, determine the OBSS-PD and TXP based on second parameters.

18. The non-transitory computer-readable storage medium of claim 17, wherein the second parameters permit the wireless device to set the OBSS-PD to a higher value without lowering the TXP, and wherein the first parameters indicate that OBSS-PD and TXP are to be determined based on a minimum OBSS-PD and a maximum TXP, and indicate the OBSS-PD is to be lowered if the TX power is raised.

19. A method performed by an access point, the method comprising:
determining an overlapping basic service set (OBSS) power detect (PD)(OBSS-PD) and a transmitting power (TXP) based on first parameters; and
if the wireless device has not received a frame from an OBSS master station that does not belong to a same management domain as the wireless device, determining the OBSS-PD and TXP based on second parameters.

20. The method of claim 19, wherein the second parameters permit the wireless device to set the OBSS-PD to a higher value without lowering the TXP, and wherein the first parameters require that OBSS-PD and TXP be determined based on a minimum OBSS-PD and a maximum TXP, and require the OBSS-PD to be lowered if the TX power is raised.

21. An apparatus of a station comprising memory and processing circuitry coupled to the memory, the processing circuitry configured to:
decode a frame comprising parameters from a master station; and
determine an overlapping basic service set (OBSS) power detect (PD)(OBSS-PD) and a transmit power (TXP) based on the parameters, wherein the parameters are one from the following group: parameters that permit the station to set the OBSS-PD to a higher value without lowering the TXP; parameters that require that OBSS-PD and TXP be determined based on a minimum OBSS-PD and a maximum TXP, and require the OBSS-PD to be lowered if the TX power is raised; and, parameters that indicate the station should use a default OBSS-PD and a default TXP.

22. The apparatus of claim 21, wherein the processing circuitry is further configured to:
decode a second frame from a second master station not part of a same management entity as the master station, wherein the second frame comprises second parameters;
encode a third frame comprising the second parameters; and
configure the station to transmit the third frame to the master station.

23. The apparatus of claim 21, wherein the station is not associated with the master station and the parameters further comprise a transmit and operating parameters information element, the transmit and operating parameters information element comprising channels for the station to operate on.
